(19) United States
(12) Patent Application Publication
(10) Pub. No.: US 2025/0346424 A1
(43) Pub. Date: Nov. 13, 2025

(54) A RACKING SYSTEM FOR CARS IN A CONTAINER

(71) Applicant: Martin CLIVE-SMITH, Leek Wootton (GB)

(72) Inventor: Martin Clive-Smith, Leek Wootton (GB)

(21) Appl. No.: 18/869,711

(22) PCT Filed: May 30, 2023
(86) PCT No.: PCT/GB2023/000028

§ 371 Date: Nov. 26, 2024

(30) Foreign Application Priority Data
May 27, 2022 (GB) 2207853.9

(51) Int. Cl. B65D 85/68; B65D 90/00

(52) U.S. Cl. CPC B65D 85/68; B65D 90/0053; B65D 2585/6867

(57) ABSTRACT

A racking system for loading vehicles outside the container onto a base, the base having rollers to roll it into the container. In the container are four posts removably fixed to the side walls of the container. The bases are telescopic to any length to suit different vehicle wheelbases. The stack height and weight of the bases complete with posts and lashings is low for compact stacking and empty returns. The system allows that bases set to different vehicle lengths can be stacked one upon another and shipped. The bases and posts can be stacked outside of the container into columns of bases and rolled into the container as one unit for empty return shipping.

### BACKGROUND

In the field of shipping vehicles in containers, there is much prior art relating to the design, manufacture and use of racks, frames or bases used to containerise cars. Some companies have taken these into commercial production. When facing the multitude of problems to be solved from variations in car size and geometry, costs of shipping, cost of manufacture, cost of operation and training in its use, access, and space for working in the container, storage and return shipping of empty racks, and critically personnel safety, a single all-encompassing yet commercially viable solution has been hard to find.

Securing a heavy, delicate, finely finished, valuable car inside a container without making a single mark on it is itself a major challenge and the car manufacturers have therefore demanded that the cars be loaded onto any racks outside of the container, not inside as once they did allow. Having got the car inside, the very substantial rough transport on rail, oceans and seas, handling impacts in dockland terminals, and jolting along bumpy roads, all contrive to make the containerization problem yet more difficult.

The market too is getting more difficult as humans are getting larger and cars wider, yet for the foreseeable future the width of containers remain the same. Typical shipping containers of the closed type with side walls are 8 ft wide externally with a maximum internal width of 2352 mm and a door opening width a minimum 17 mm less at 2335 mm. Over the decades of evolution the containers now have almost identical geometry of dimensions and the sidewalls of the containers have side panels of corrugated steel with regular known geometry.

The width across the outside of the tyres and alloy wheels of family cars is commonly about 1850 mm whereas MPVs and off road vehicles can be 2 m and more leaving barely 150 mm available for a worker to pass between a car and the sidewall of a container. Side mirrors and other projections only reduce the gap still further. At the tyre level steering onto a rack outside the container can lead to the slightest of errors snagging a tyre or alloy wheel on a rack causing a disproportionate expense to remedy the damage. Every centimetre of extra space to avoid damage provides considerable advantage.

In the prior art attempting to meet all these challenges, existing racks of prior art tend to focus on how to make the upright posts strong enough and rigid enough to support a vehicle up off the ground both outside the container when loading the device and then inside able to withstand the rigours of container transport. Some prior art includes Rokko Engineering C.Ltd. EP 3 048 067 A1, Trans-Rak International Ltd. WO.2018/178610 A1 and Lohr Industrie U.S. Pat. No. 10,632,894 B2. As well as being strong the combined assembly of posts, base, top frames and yet more space for a second bottom frame takes away valuable cargo space needed for the vehicle wheels and body, and yet all must be able to pass through the container door of width 2335 mm.

The tare weight needs to be low to minimise unit shipping costs, and the racks need to be compact to maximise the number of units carried on any one container. Labour cost continue to rise so simple quick operations are a major goal. The prior art has until now tended to be lacking in meeting the objectives, and/or comprise sophisticated assemblies, being complex and bulky with many components and pins and needing skilled operators to put them together.

Finished cars awaiting containerisation are stored in warehouses or car parks. Ideally they would not be charged with fuel or electrical charge but moved around by other means. Too containerise the vehicles they need to be lifted off the floor of the container and secured high up for a second vehicle to be loaded underneath. That poses the problem of how to get the car raised up and locked with no space for workers to enter the container which is why the prior art has gone for massive collapsible frames. It cannot be done with a forklift because to lift 3 tonne passenger car with a centre of gravity 2.5 m from its end needs a forklift truck with 12 tonne rating. Such a forklift is too big and heavy to go in a container. Only forklifts of 3 tonnes at 1.2 m reach are allowed. If a rack could be devised for moving cars around the warehouse or factory floor and have the cars lashed on them parked and ready to be put into a container and then moved into the container using simple handling equipment and there fixed quickly or automatically into a container that would be an advantage.

Compact empty stowage and transport is a commercial necessity. To achieve compactness for complex structures some racks in prior art must be dismantled into many constituent parts or include sophisticate hinges, pins and retractable mechanisms. Significantly re-assembly is then needed at the export destination. It all takes time and skill to pack these together and in manufacture the number of loose items and hinges and strict tolerances of fit needed to link it all together accurately and structurally add cost and time and make them damage prone. If a simple way could be devised to fit up to 40 racks in a 40 ft container without having to go through the rigmarole of disassembling the racks and then reassembling them would be an advantage.

In operation, known racks can have side rails made in two lengths of tube joined telescopically. Tubes with their torsional stiffness may be essential to these designs because of the need to support the posts strongly upright. Yet to avoid something sometimes known as ‘sticky drawer effect’ concerning the jamming of furniture drawers, the ratio of drawer length to width should be more than 1.5:1 to prevent jamming. Operating telescopic racks has similar problems. The prior art racks and the present invention are of 2.3 m width with longitudinal rails only 2.2 m. 3.4 m length is needed to avoid jamming.

The problem is made worse by natural friction, corrosion, unpainted surfaces, lack of lubrication. Forming of the holes for fasteners can cause snagging between mating sections. If these problems could be overcome with a better technology, then that would be an advantage.

Laying out and marking the locations for the racks in a dark container is awkward and time consuming. Loading 4 family cars into a 40 ft container leaves very little space for geometric error. The car must be measured, and the racks placed and secured accurately in the container within one or two centimetres. Setting out the 12 m internal length inside a dark container to nearest 5 mm correctly leads to errors. Container side wall corrugations are standardised internationally and have a pitch of 278 mm so that to achieve repeatability of setting up simply by counting the number of corrugations, and by having the posts and bases pre-set for the vehicle could increase productivity and quality.

Stacking empty frames into columns is typical in prior art the more the better for low-cost shipping. Lohr and Rokko achieve 10 to 15 racks per 40 ft container. The number of racks in the columns is governed by their height because to be able to pass under the door header of a container, and their tare weight because they must be handled in some way to get them in and out of the container and once inside be moved all the way down the length of the container. Stacking one empty rack on another, or loading a rack with a vehicle loaded on it within a container using a small forklift truck is awkward because the driver cannot see what is happening. No person can be inside the container and assist when this is happening. So this work needs to be done outside the container. If the stacking process too could be done outside the container where there is plenty of space, and if several racks stacked in a column could be moved as one overcome the massive weight problem of a stack so as to be done with a small forklift truck that would be an advantage.

Since there is so little space to work in inside the container, and also there being some danger attached to working in such cramped conditions, any degree of automated connection for engaging and locking the racks together that could be provided would be a bonus.

To make a strong free-standing frame independent of the container to be loaded with vehicles when outside the container and then push the rack into the container is a good way to save operational complexity. However, the problem is that such rack strength requires bulk and weight of steel. If such a frame can get through the container doorway, there remains a gap between the frame and the side walls of the container of at least 30 mm leading to swaying during transport and fatigue cracking of the frames. A rack that has much reduced gaps yet can be loaded outside the container would be advantageous.

Naturally, once a racking system for vehicles such as cars has been found the advantage follows that it could be useable for all vehicles so in the present invention the term vehicle is envisaged to include trailers, caravans, motorcycles, and vehicle bodies.

Lastly but most importantly, safety of workers requires that men and machines are best kept apart. In this field, that means that they do not venture between the front end or side walls of the container and the racks. If a way of securing the racks to the container high up and also on the floor as required could be achieved without workers being in the vicinity, that would be an advantage.

### SUMMARY

According to a first aspect of the present invention there is provided an assembly of a shipping container and a racking system for securing vehicles according to claim 1.

According to a second aspect of the present invention there is provided a method for loading one or more vehicles into a container and securing them for shipping according to claim 24.

### BRIEF DESCRIPTION OF THE DRAWINGS

The present invention will now be described, by way of example only, with reference to the accompanying drawings in which:

FIG. 1 shows a base in perspective with posts nested within it.

FIG. 2 shows a side elevation of two cars loaded into a container on the bases.

FIG. 3 shows a preferred arrangement of a connection means comprising a spigot and slot plate.

FIGS. 4A, 4B, 4C, 4D, 4E shows the operational steps for engaging a spigot with a slot plate.

FIGS. 5 and 6 show alternative orientations of the slot plates.

FIG. 7 shows an alternative connection means being a fixed spigot and adjustable connector.

FIGS. 8A and 8B show alternative connection means.

FIG. 9 shows a perspective view of a base anchored to the container floor.

FIGS. 10A and 10B shows the width effects of different post positions.

FIG. 11 shows stacking of bases into columns for empty shipping.

FIG. 12A shows handling means to lift the front end of the base remotely.

### DETAILED DESCRIPTION

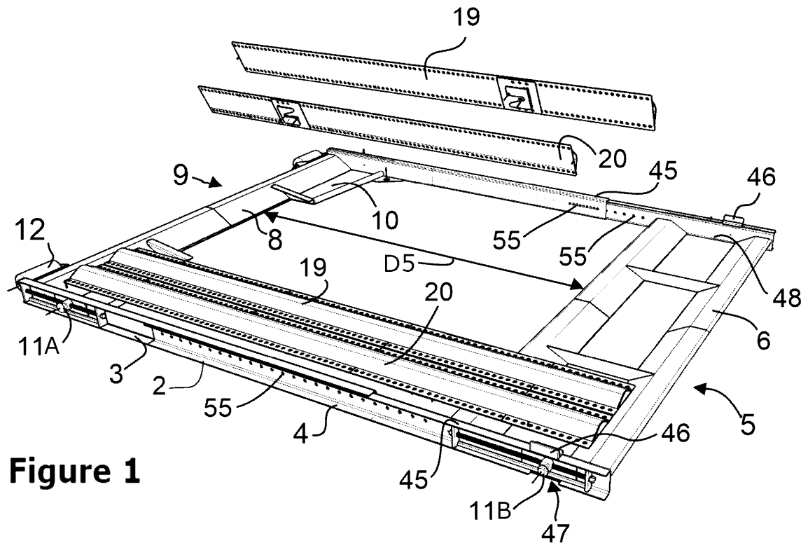

In FIG. 1 an embodiment of the invention comprising a base 1 with a front end 9 and a rear end 5. The base 1 is a rectangular shape comprises a transverse rear support 6 connected to a transverse front support 8 via a pair of longitudinal telescopic side rails 2. The side rails 2 are made from two sections, a rear side rail 4 and a front side rail 3, one sliding inside the other. In this example the front side rail is an outer member formed as a channel section from pressed steel and the rear side rail slides inside it and can be a channel section too. Pierced through the webs of the channels are holes 55 so that when the base is telescoped to give the required length one of the holes 55 in the rail 3 lines up with one hole 55 in the rail 4 through which a fastener such as a nut and bolt, rivet, anti-loose fastener or screw can then be fixed to fix the length of the base 1 for use.

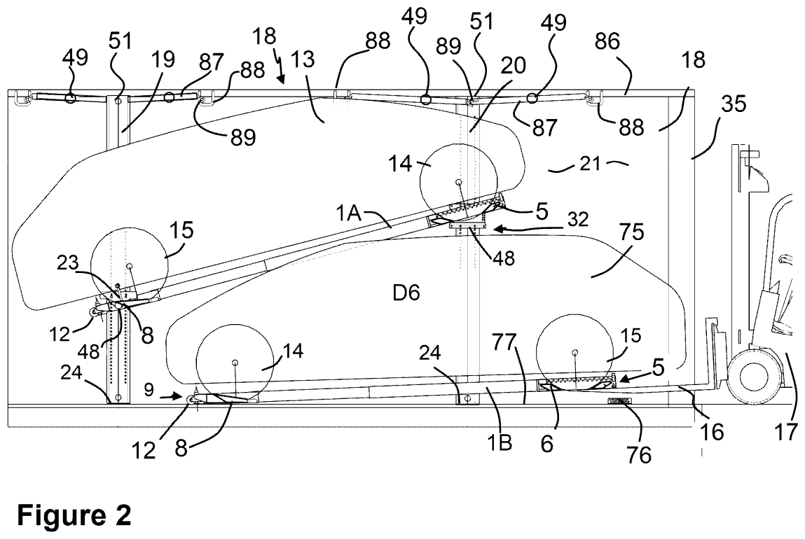

The telescopic action enables the longitudinal distance D5 between the front and rear supports to be adjusted to support vehicles of differing wheelbases D6 shown in FIG. 2 as required. The front support has attached two rollers 12 or similar wheels such that when the rear end 5 is lifted up off the floor by a lifting machine such as a forklift truck 17 with tines 16 the base can be rolled as a barrow might be along a floor 77 surface.

Returning to FIG. 1 the base being empty of cars is being made ready for shipping and two of the four posts 19, 20 needed for the system are shown nested within the base 1 between side rails 2 and a further two posts are arriving to be stowed in the base as are the first two. If the base is telescoped out for say a car with 3.2 m long wheelbase, then the posts can be coupled together to through their holes using fasteners to make a longer assembly of two posts able to span to and be supported by the support frames.

At the front side rail 3 and in this example rear side rail 4 are seen spigot 11A at the front and one spigot 11B at the rear projecting transversely from the base 1 on each side. Projecting from the rear side rail 4 on each side is a guide 46 projecting above the top surface 45 of the side rail 2 which when one base 1 is stacked on top of another, the guide 46 enter a recess 47 in the underside of the rear side rails 4 the recess being closed off on the inward side of the side rail by a plate 48 with the result that when two bases are located one on the other the guides 46 enter the recesses 47 and index one base on another to align the rear supports 6 of each base with each other. The bases are then restrained against sliding or skewing in a horizontal plane and have the side rails 2 resting substantially on each other.

In operation, to avoid jamming of the rails as they are being telescoped in or out of each other the outermost side rail in this example being front side rail 3 is larger than rear side rail 4 which slides inside it. The side rail 4 is made as an open section which can be paint inside and out and serviced with lubricant on the inner faces and in addition so that when the rails become skewed one to the other when sliding one inside the other the inner rear side rail 4 has the freedom to deflect and relieve its sliding contact with the front end rail and thereby prevent jamming of one rail inside the other. During a maintenance schedule, the side rails can be extended telescopically so that their touching faces can be exposed for servicing such as lubrication, corrosion removal and repairs.

The front support 8 has floor pans 10 to support the wheels 14, 15 of a car 13 seen in FIG. 2.

Adjacent to each corner of the base where side rails meet end supports are located part of the connecting means comprising front end connectors and rear end connectors, preferably comprising a male connector or a female connector.

However connectors that take similar form might not be male or female and are envisaged to be connected with fasteners. Other connectors might be devised or adapted from prior art and it is envisaged that these can be adapted for use as a connection means for the present invention.

FIG. 2 shows a side elevation of a container 18 with the near side wall removed to show the interior where a car 13 is supported by a first base 1A above the floor 77 with its front wheels 14 on rear support 6 and rear wheels 15 on front support 8.

To secure the car, the wheels are lashed to the supports 6, 8 by known means such as ratchets and webbing straps. Two vertical posts 19, 20 are fixed upright and removably to the side 21 of the container 18 and these would be replicated on the other sidewall of the container which has been removed from this illustration. On each pair of posts 19 and 20 are connecting means 48 (to be detailed later in the description) securing the front end 9 of the base 1A and the rear end 5 to the posts and thus securing the car 13 to the actual container structure between floor 77 and container ceiling 23. The prior art may have other connection means which could be used in the racking system and it is envisaged that these may be used with the present invention either at the front end 9 or the rear end 5 or both of the base 1. Furthermore not just one connection means claimed in the present invention may be used and it is envisaged that a claimed connection means be used at the front end 9 of the base 1B and that a known means might be used at the rear end 5 of the base 1B or vice versa.

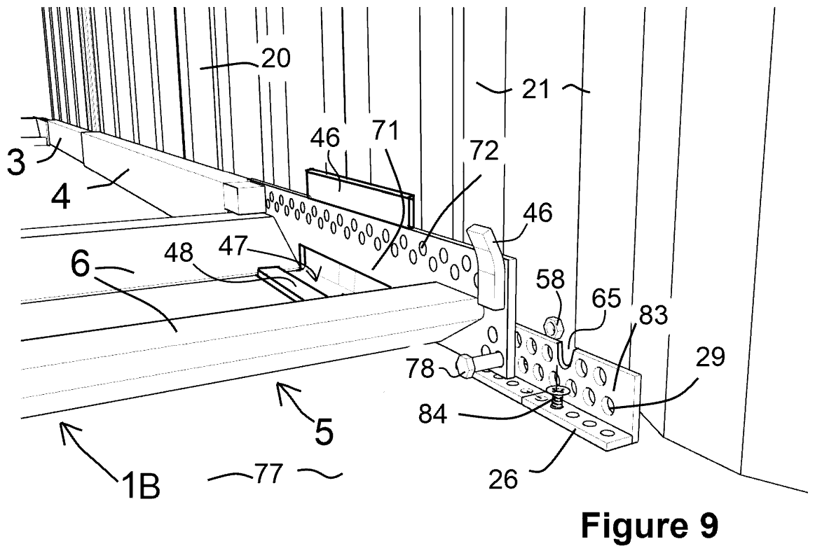

A second car 75 is shown on a base 1B rolling on the floor 77 under the first car 13 by a handling means here comprising a forklift truck 17 lifting the rear end 5 and rolling on rollers 12 at the front support 8. The forklift truck is linked releasably to the rear support 6 with flexible ties so that it can articulate, push and pull on the base as well as lift the support without dropping it until released. Once the base 1B is in the required longitudinal location along the floor 77, the base 1B can be lowered by the forklift truck and engage the base 1B via anchor plates 83 fixed to the floor 77 as seen in more detail later in FIG. 9.

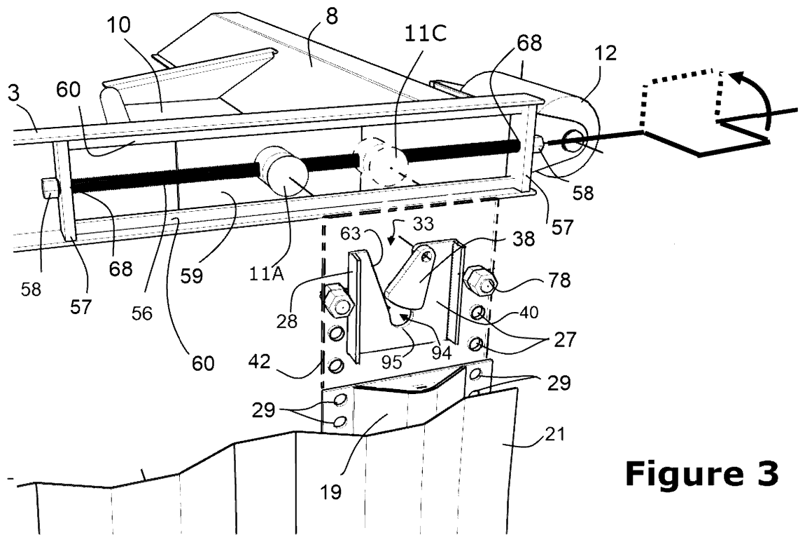

In FIG. 3 details of the preferred arrangement of a connection means comprising a male connector comprising a spigot 11 and a female connector comprising a slot plate 40. The view shows the front corner of the base 1 with roller 12 and front side rail 3. The spigot 11A is welded to a back plate 59 which is slidable between the channel shaped side rail 3 and two rails 60. A drive screw 56 is mounted for rotation within bearing holes 68 formed in the two brackets 57 and is driven for rotation via a nut 58 welded to each end of the screw 56. The spigot, or alternatively the back plate, is drilled and tapped with a thread to receive the drive screw so that by rotation of the drive screw 56, the position of the spigot along the length of the side rail 3 between the brackets can be adjusted at will. Rotation can be carried out manually with a spanner or by using an electric drill.

Once the screw 56 stops rotating, the back plate and thus spigot 11 is fixed in position by the friction on the screw thread for use. To engage the spigot is a slot plate 40 mounted on a back plate 42. The slot plate 40 is welded to the back plate 42 via spacers 30 to make a space 33 which has holes 27 formed in it to line up with holes 29 in the post 19 and be fastened to the post by bolts 78. Note that for illustration, the back plate shown has its main surface removed to enable the viewer to see the interior workings of the slot plate and catch 38. The array of the holes 27, 29 allow height adjustment up and down the post 19. The slot plate 40 has a catch 38 mounted pivotally to it which by rotation closes the open end 69 of slot 94.

In operation the base 1 is manoeuvred into position so that the spigot 11A aligns over and with the slot 94 and can be lowered to engage with the slot plate 40. If there is some misalignment the position of the spigot 11A it can be adjusted by rotation of the drive screw 56 to the location occupied by spigot 11C shown in dotted line and the base lowered to connect spigot to slot plate.

To minimise the need to have a long screw 56, a second spigot located perhaps near 11C can be formed as part of back plate 59.

The operation of engaging and securing if required can be automatic and achieved by the handling means handling the base from the rear of the container so that no worker be needed in the vicinity.

To release the catch 38 can be done manually because the spigot 11A is safely cradled and supported in the slot 94. Thus a worker can walk under the base 1 and flip the catch 40 open and then withdraw to a safe zone.

Alternatively a long-reach pole can be provided to grab and rotate the catch 38 about its pivot.

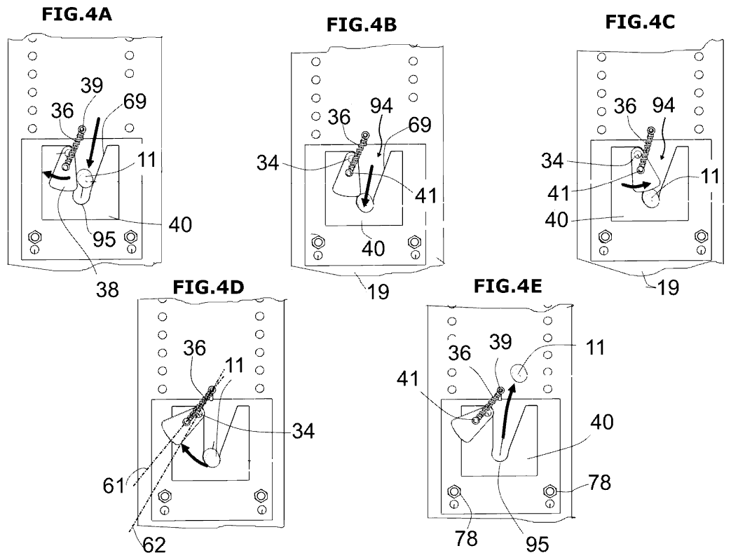

The catch 38 is preferred to be spring loaded with spring 36 to keep it closed whatever orientation slot plate 40 might be mounted. Its operation is now illustrated in FIG. 4.

In FIG. 4 the steps for engaging a spigot 11 with a slot plate 40 are illustrated.

FIG. 4A—The spigot 11 enters the open end 69 displacing the catch 38. The catch resists being rotated about is pivot pin 34 by a spring 36 to bias the catch towards the closed position as illustrated in FIG. 4C. Other biasing arrangements will work including compression, torsion and leaf spring arrangements. Tension springs are preferred to provide the over-centre mechanism as described.

FIG. 4B—The spigot continues down until it comes to rest on the closed end 95 of the slot

FIG. 4C—The spigot clears contact with the catch 38 so that the spring 36 as a tension spring can pull the catch into the closed position trapping the spigot against lifting out.

FIG. 4D—To free the spigot 11, the catch 38 can be rotated manually against the tension of spring 37 until the axis 61 of the spring lies beyond the axis between pivot 34 and spring anchor 63 thus holding open.

FIG. 4E—The spigot is now free to be lifted of the slot 94 and the base free to be moved away by handling means. The catch 36 can then be reset to the position seen in FIG. 4C ready for automatic operation.

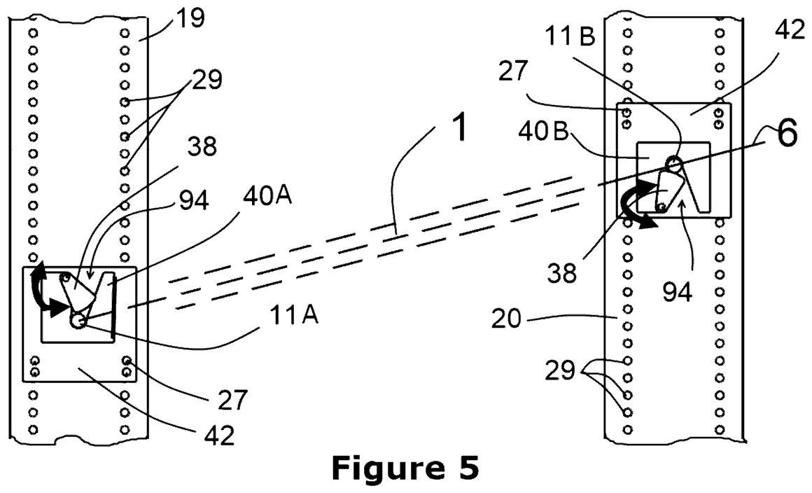

In FIG. 5 the orientation of the slot plates 40 is different with 40B being rotated 180 degrees from the position of slot plate 40A. Slot plate 40A on post 19 has its open end 69 facing up, and slot plate 40B on post 20 has slot open end 69 pointing down. In this operation, the spigot 11A is engaged first as described around FIGS. 3 and 4. The rear support 6 of the base 1 indicated in dotted line is then raised up using the spigot 11A as a pivot until the spigot 11B rotating through an arc aligns and continues to be raised until spigot 11B enters slot 94 and then is trapped by catch 38 as it is opened and then closed automatically under the action of the spring 38 there to support the spigot and base.

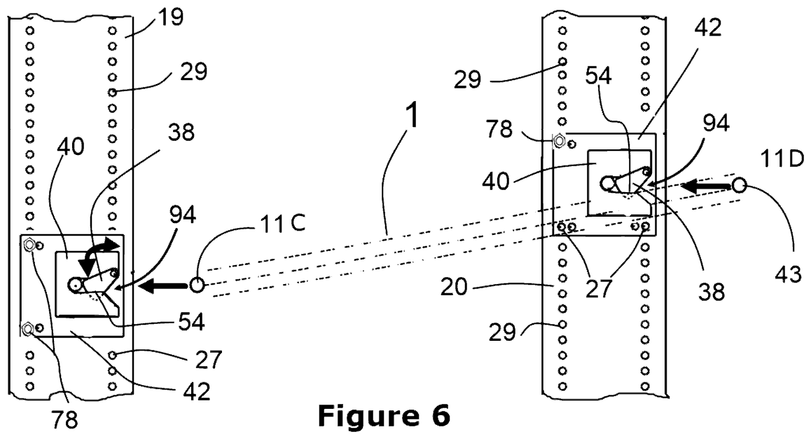

FIG. 6 shows an alternative arrangement wherein both the slot plates 40A and 40B are orientated horizontally facing the rear doors of the container and the base 1 illustrated in dotted line is being carried along inside the container already set at the transport height so that the spigots 1C and 11D are aligned with the open end 69. Further movement of the base 1 towards the posts 19, 20 cause the spigots 11C, 11D to engage with the slot plates 40 and the base is now secured to the posts.

It is envisaged that if the spigot 11D were set on its drive screw 56 back for example 15 cm, then the pivoted raising of the rear support 6 about spigot 11C as described earlier in FIG. 5 could take place and once aligned horizontally, the spigot 11D could be screw driven to engage with the slot plate 40 and trapped with catch 38 as before.

Once again the catches 38 can be opened manually and because the spigots are all resting on the bottom edge 54 of the slot 94 the base 1 will not fall down albeit that it must be retained horizontally at least by a forklift truck located at the rear support 6. The rotation of the slot plates 40 can be made off the horizontal counterclockwise as viewed to improve the safety of the support still further.

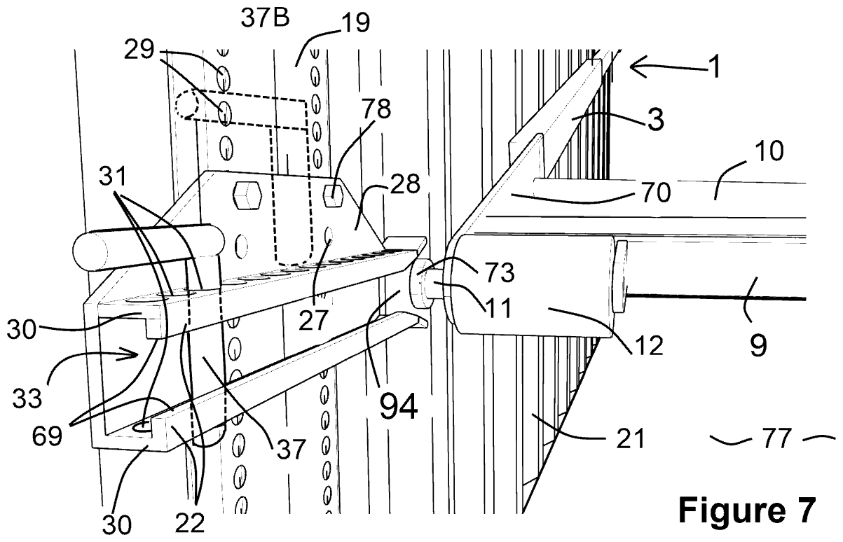

In FIG. 7 if the position of the spigot 11 in this example is not adjustable longitudinally along the side rails 2, then longitudinal adjustment is necessary by other means. Two examples of longitudinal adjustment are proposed.

Firstly, in FIG. 7 a longer slot 69 with an array of holes 27 can be provided. The FIG. 7 shows a close-up perspective view of a connector means comprising a spigot 11 fixed projecting transversely from side rail 2 near roller 12 being moved towards the slot plate 40 which in this example is formed from plates 22 and the closed end by an adjustable pin 37 adjusted by moving it along the slot 69 and fitting it through holes 31 to set the longitudinal position required for the base 1 and its spigots 11. Back plate 42 is fastened to the post 19 by bolts 78 passed through an array of holes 27 in back plate 42 through holes 29 arrayed in the post 19 fixed to the side wall 25. No car is shown on the base 1 to better show the fastening operation. The front spigot 11 is fixed to a back plate 70 being a non-adjustable extension of the side rail 2 in this example front side rail 3. Even though the base 1 is seen tilted to a typical angle of about 15 degrees to the horizontal the retainer 73 being a flange formed as part of the spigot 11 can enter the space 33 enclosed in this example by plates 22 and spacers 30. Made through the spacers 30 are an array of holes 31 through which an abutment pin 37 can pass to close the end of the rail so that when the retainer 73 slides along the rail 22 it encounters it preventing further travel. A second pin 37 indicated by dotted line 37B can then be placed behind the spigot 11 to capture it and prevent movement of the base 1 vertically by the spacers 30 and horizontally by the pins 37 and transversely by the plates 22 being another form of the slot plate 40 closed in around the retainer 73 of the spigot 11. The spigot 11 being a single shaft can now be used as a pivot about which the rear end 5 of base 1 can be raised or lowered.

The back plate 42 can be removed by unfastening the bolts 78 and if the base 1 is properly supported by something like a chain hoist 80 suspended from the top of the post 19 and attached with tie 81 to the front support 8, then the front of the base 1 can be lowered safely to the floor 77 illustrated in FIG. 3.

To fit the second pin 37 requires manual operation. If this is not acceptable operationally, then a spring loaded latch or other form of automation of connecting means is described earlier around FIG. 4.

The spigot 11 is slotted into the open end 69 travelling in a horizontal direction. If the same connection means was used at the rear post 20 and horizontal movement applied simultaneously to all four connections then the spigots could be devised in a shape not requiring pivotal movement, for example it could be formed a horizontal plate or blade or a plate shaped like flange 30 turned upside down to engage transversely with the flange 30. A single retaining pin 37 could be used to pass through the horizontal elements.

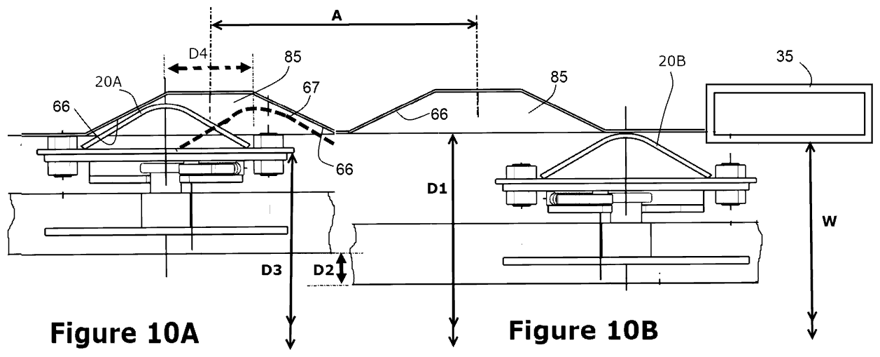

Secondly longitudinal adjustment is proposed to be provided with a spigot 11 which is fixed non-adjustably to the side rails 2. In this example the posts 19, 20 can be adjusted longitudinally along the length of the side walls 21 being of the type illustrated and describe around FIG. 10B. So, for example the connectors at the front end 9 and rear end 5 might be of the type slot plates with catch as illustrated around FIGS. 3, 4, 5, and 6 set by post positions to receive a spigot 11 of non-adjustable position along the side rails.

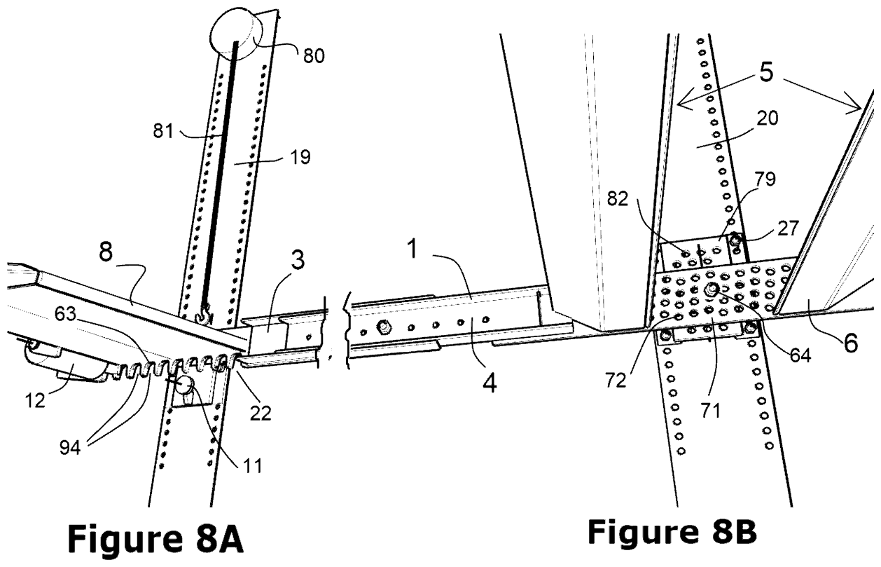

In FIGS. 8A and 8B there is seen a close-up detail of two other connection means. Firstly, in FIG. 8A the spigot 11 is welded to a back plate 42, cantilevered out from the post, and fastened to the post 19 with bolts 78 through holes 27 as before. Height adjustment is made by selecting the required hole positions. However horizontal adjustment can be made on the base 1 through the provision of a multi-slot plate 63 having several slots 94 made in its underside. In operation the base 1 is manoeuvred over the spigots and carried along the container until the required location is reached and then lowered so that one or other of the slots engages with the spigot 11. The pivoting about the spigot is caried out before by the raising of the rear end 5. If small adjustment longitudinally is needed, the post 19 can be adjusted longitudinally as described later in FIG. 10.

In FIG. 8B a connection means for operation at the rear support 6 is proposed. Here the base 1 provides sufficient access to the connecting means for it to be operated manually with the rear support being held up by the handling means or by a safety chain or other known means. Plate 79 is fastened to the post 20 via holes 27 at the required height. To the left and right of the plate 79 are yet more holes 82 so that as the base 1 can have rear end 5 raised by handling means pivoting the base 1 in an arc about the spigot 11 at the front of the base until a single one of the holes 72 align with a single one of holes 82 and a single fastener such as a bolt can be fed through them to bolt plate 71 to plate 79 and thus secure the base 1 at the height and longitudinal location required. To align two holes 72 with two holes 82 and gain a structurally sound fitting connection is not always reliable because the plate 71 cannot be moved or rotated in a vertical plane once the spigot 11 is held in the plates 22 and pins 37. The post 20 is of the type recessed into the valley 85 of the side wall described later around FIG. 10A so to provide access for a bolt behind the plate 79, the plate 79 is formed to project from the inner surface of the post 20 to the container interior. Alternatively, the holes 82 can be drilled and tapped with screw thread and a bolt 64 used to fasten the plate 71 directly to the plate 82. In FIG. 10B it is seen that the post 20B can be located well away from the side wall corrugation 21 to enable the plate 71 to be fastened directly to the post 20.

In FIG. 9 one can see how a base 1B seen in FIG. 2 can be fixed to the floor 77. An anchor plate 83 with foot plate 24 is fixed via screws 84 to the floor 77. Plate 71 is lowered down until holes 72 align with holes 29 to allow a fastener to be passed through the aligned holes and fix plate to anchor plate to floor. An alternative to the bolting of the anchor plate 83 to the plate 71 is to make the profile of the anchor plate 83 the same as the guide 46 and so by screwing the anchor plate 83 to match the location required for the recess 47 to be when the base 1B is loaded into the container, the recess can be lowered over the anchor plate and thus retain the base 1B in the horizontal plane without need of fastener 78.

The anchor plate 83 can be fixed on the floor 77 before the bases are brought into the container by pre-planning and by making the track of the rollers 12 being narrower than the upright of the post 83.

The anchor plate can have a slot 65 formed in it to receive a spigot 11 on a base 1 to anchor the base to the floor if so selected from one of the connection means.

Horizontal movement transversely especially at the front support 8 of the base 1 during transit is prevented by contact between a post 19 or 20 and side rail 2 and by the two anchor plates 83 one on each side.

FIGS. 10A and 10B show detailed plan sections of a typical container side wall 21 with vertically corrugated section of steel sheet less than 2 mm thick having valleys 85 pressed into it the valleys being pitched ‘A’ typically of 278 mm. The door opening width W of a container is known to be typically 2326 mm yet the interior width of the container between the side walls 21 denoted D1 is 20 mm wider at 2346 mm.

In FIG. 10A post 20A is seen partly recessed into one of the valleys 85 of the wall 21 to provide additional cargo space for the vehicles. Preferably the width D3 between two facing posts would be as large as the door width W. If the posts are located as in FIG. 10B then the loss of internal width is denoted by arrow D2 on each side of the container and can be significant.

Returning to FIG. 10A it can be seen that the post 20A can move longitudinally a distance D4 within the valley 85 to a location indicated by dotted line 67 until the post 67 is confined by touching the sides 66 of the valley 85. Adjustment of the post's longitudinal position can be critical to optimising the close-fitting number of vehicles loaded within the container.

In operation, the top of post 19, 20 is lashed to the top side rails 86 seen in FIG. 2 via ratchet straps 87 to known lashing hoops 88 on the top side rails. The straps have hooks 89 hooked into holes at the top 51 of the posts 19,20. By slackening or tightening the top straps 87 by adjusting ratchets 49, the top 51 of the posts 20 and thus the position of the connector means 48 can be adjusted side to side longitudinally.

If required the posts 20A can be made wider or deeper to bear on the sides 66 of the corrugation valleys and help resist longitudinal movement, the tension in the straps becomes less critical for securing post 20A than the freely positioned post 20B which can be positioned anywhere along the side wall.

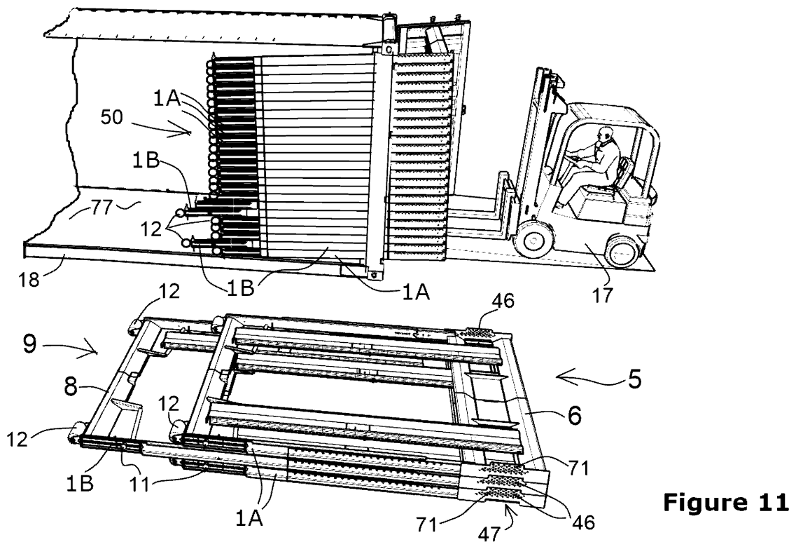

In FIG. 11 there is seen a container 18 with side wall removed to see inside is being loaded with a column of bases 1. As illustrated a standard 40 ft long container has a typical internal length of just over 12 m. The door height is typically 2550 mm so 11 number pairs of bases 1 and their posts of depth 110 mm could be stacked one upon another and rolled into the container.

However, the cargo weight in a container shipped internationally is limited to around 22 tonnes. So technologically a balance has to be found between base weight, base strength and base height. Too high and not many bases will fit in the container. Base weight and the same applies. Base strength and rollers and side rails might not manage to support the loads. 4 columns of 11 pairs should not weigh more than 500 kg each to not overload the forklift truck and container.

The overall length of the bases 1 has been described and the illustration shows a stack of 3 bases 1A on 1B on 1A of different lengths each with posts 19, 20 nested and supported within. The bases are indexed up to the rear support 6 and located together with the guides 46 in recesses 47. The full column 50 includes bases 1B of differing length to bases 1A being rolled into the container with forklift truck 17.

To be able to roll such a column needs strong rollers at the front support 6 and strong side rails which tend to conflict with the need to make them lightweight and shallow to maximise cargo space and economical empty transport. Thus the side rails 2 are made substantially of a constant height and profile to enable them to be stacked one on another. They are located one on another by the guides 46. Yet because there are no hinged walls or posts or post supporting structure the side rails can be made deep at 100 mm or so and thus strong yet lightweight. The result is that the total stack height is no more than the side rail height, the columns can be assemble outside of the container being safer and easier for all access of machines and workers, mixed length bases can be stacked together, very short stacks as short as 2.7 m to fit 5 columns in a 45 ft container can be made without increasing the stack height, and these can be rolled in as one into a container with a small forklift truck. With the present invention between 6 and 11 sets of bases in a column can be rolled into the container as a single unit.

If a single base happened to be needed to be put into the container for some reason, it can be slotted on top of another base from one end through the restricted doorway of a container, the rollers of the base running on the top surface 45 of the side rails 2 of the lower base to help stabilise the process.

It should be appreciated that the time it takes to remove the bases 1 and posts 19, 20, undo bolts 78, slide telescopic side rails 2 to make them more compact, remove fasteners 78 from posts all take time and handling skill. If the length of the bases 1 could remain unaltered and all or the majority of them could be shipped unadjusted and return to base to pick up yet more cars of the same size and shape, then the posts with their fastened plates and rails or spigots and the bases with their supports would need no adjustment yet be able to be shipped economically in columns 50.

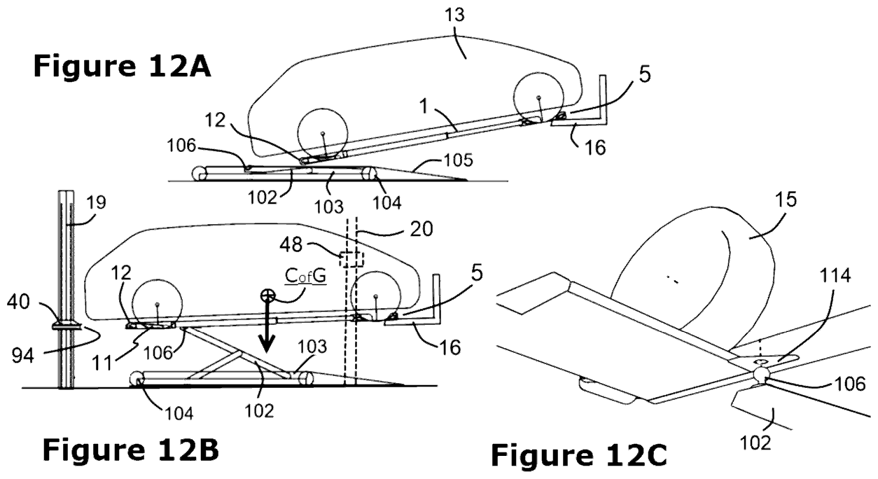

FIG. 12A shows one handling means to lift the front end of the base 1 for loading and unloading the bases with cars 13 or other vehicles. A jacking trolley 69 comprising a chassis 103 having a jack 102 mounted within the chassis 103 which mounted on wheels 104. The base 1 with car 13 lashed to it is rolled up the ramp 105. Once loaded onto the jacking trolley the jack 102 is powered upwards manually, electrically, hydraulically of known means, to engage a hitch 106 with a socket 114 accessed from under the base as seen in the perspective view FIG. 12C. The forklift then pushes the base with the car now mounted on the jacking trolley and the forklift truck inside the container towards post 19 fitted with connection means 48.

In this example the front of the base has connection means comprising spigots 11 and the post 19 has connection means comprising slot plates 40. Once the connection means on base 1 and posts 19 are close to alignment the operator of the forklift truck is able to manoeuvre the front support 8 by raising and lowering the rear support 6 causing it to pivot about the hitches 106 in the sockets 114, drive the base back and forth along the floor, and also side shift the forklift tines to skew the position of the connectors for example spigots 11 if necessary, all without a worker being near the danger zone at the front of the base. It may not be necessary to change the height of the hitches 106 but this is a further manoeuvring option. It should be appreciated that the centre of gravity of the base 1 and/or car loaded on it denoted CoG must be positioned between the sockets 114 and the rear support 6 to ensure stability. Once the connector such as spigot 11 is connected with the slot plate 40 for example, the rear end 5 can be lifted still further and in doing so, the socket 114 lifts off the hitches 106. The rear connection means 48 can then connect the base 1 to post 20 shown in dotted line and as in earlier descriptions. The lifting machine 69 and forklift truck can now withdraw from the container.

Although a forklift truck is the preferred lifting machine other lifting machines such as scissor lifts, pallet trucks, grab trucks, cranes, hoists, and so on are available and envisaged as viable substitutes for the forklift truck.

It is envisaged that more than one vehicle can be carried on the base such as motorcycles. Additional stabilising and support frame is envisaged.

1.-20. (canceled)

21. An assembly of a shipping container and a racking system for securing vehicles to the inside thereof for onward transport, wherein:
the shipping container comprises two longitudinal sidewalls and a floor; and
the racking system comprises:
a base comprising a transverse front support connected to a transverse rear support via a pair of longitudinal telescopic side rails enabling adjustment of a distance between the front and rear supports on which a vehicle is to be supported, the base having rollers at a front end to enable the base to be rolled along a floor when a rear end thereof is raised;
four separate removable posts fixed to each of the longitudinal side walls, the posts having arrays of holes formed in them along their lengths; and
connection means connecting the base to the shipping container indirectly via the posts such that the base is located above the floor, creating a space below the base to receive at least part of a further base rolled along the floor into the space, for securing to the container using securing means.

22. The assembly of a shipping container and a racking system as in claim 21, in which the connection means comprises:
a bolt plate incorporating an array of holes fixed to the side rail of the base; and
a second plate incorporating an array of holes, the second plate bolted to a corresponding post,
wherein when the base is positioned in the container and a hole in the bolt plate aligns with a hole in the second plate, a fastener can be passed through the hole in the bolt plate and the hole in the second plate to secure the base to the corresponding post.

23. The assembly of a shipping container and a racking system as in claim 21, in which the connection means comprises a male connector fixed to a first back plate to connect to a female connector fixed to a second back plate.

24. The assembly of a shipping container and a racking system as in claim 23, in which the second back plate is fixed to a side rail.

25. The assembly of a shipping container and a racking system as in claim 23, in which the second back plate is fixed to a removable post.

26. The assembly of a shipping container and a racking system as in claim 23, in which:
the second back plate includes an array of holes configured to locate and fix the second back plate adjustably in any vertical location, horizontal location, and rotational orientation;
the male connector fixed to the first back plate being fastened to either the side rail or the post; and
the female connector to which the male connector is to connect, is fixed to the second back plate being fastened to the post or the side rail,
the respective back plates of the male connector and female connector both being orientated in a vertical plane parallel to the side wall of the container to enable the back plates to be connected together and when fixed to a post cantilevered out from the inner face of the post.

27. The assembly of a shipping container and a racking system as in claim 23, in which the second back plate is, or the first and second back plates are, mounted for sliding adjustment longitudinally of the side rails, or if mounted on the posts, along the length of the posts.

28. The assembly of a shipping container and a racking system as in claim 27, in which the second back plate is driven longitudinally of the side rail by a drive screw and supported in the required location by the screw.

29. The assembly of a shipping container and a racking system as in claim 23, in which the male connector comprises a spigot comprising a shaft fixed at one end perpendicularly to the first back plate and having at the other end a retainer.

30. The assembly of a shipping container and a racking system as in claim 29, in which the female connector comprises a slot plate having one or more slots to receive the spigot of the male connector, the slot having a closed end and an open end, the slot plate being so fixed to provide a space between the first back plate and the slot plate to accommodate the spigot projecting into it and the retainer at the end of the shaft.

31. The assembly of a shipping container and a racking system as in claim 30, in which the slot plates are oriented to receive or be received by the spigot when manoeuvring the base into position in the container and support at least partially the spigot.

32. The assembly of a shipping container and a racking system as in claim 30, in which the open end of the slot includes a releasable catch which can be opened from a closed position by the action of the spigot entering the open end, the spigot continuing along into the slot until clear of the catch to allow the catch to close the open end of the slot and trap the spigot in the catch.

33. The assembly of a shipping container and a racking system as in claim 21, in which the connectors in at least at the front end of the base can be connected to connectors on the upright posts fixed to the sidewalls of the container by manoeuvring of the base by handling means.

34. The assembly of a shipping container and a racking system as in claim 21 in which when the connection means at the front end of the base are connected to the posts, they can act as a pivot to enable the rear end of the base to be lifted upwards in an arc to engage the connection means at the rear end of the base to align with the connection means on the posts for engaging the base to the posts.

35. The assembly of a shipping container and a racking system as in claim 21, in which the connection means at one or both rear end and front end of the base comprises a vertical plate having an array of holes formed in it fixed to the end of the side rail which when aligned with one of the holes in the array of holes formed in the posts can be fastened directly to the post with a single fastener.

36. The assembly of a shipping container and a racking system as in claim 21, in which at least one upright post is partly recessed within a valley of a corrugation of longitudinal sidewall, having longitudinal clearance between the upright and the sides of the valley to allow it to be adjusted longitudinally within the confines of the sides of the valley.

37. The assembly of a shipping container and a racking system as in claim 21, in which at least one upright post is partly recessed within a valley of a corrugation of longitudinal sidewall, the post being recessed to bear on the sides of the valley to resist longitudinal movement of the post.

38. The assembly of a shipping container and a racking system as in claim 21, in which the posts when removed from the container can be nested between the side rails of the base supported by the support frames alone, or coupled together to enable bases to be stacked with the side rails of one base stacked upon another to bear substantially on the side rails of the base below it.

39. The assembly of a shipping container and a racking system as in claim 38, in which a number of bases can be stacked one upon another to form a single column of bases;
the bases having guides projecting above the side rails and recesses in the underside of the bases to receive them to locate one base upon another and restrain one base sliding and skewing horizontally over another when stacked;
the bases when so stacked are indexed so that one end of the bases are aligned regardless of any different lengths of bases being stacked.

40. The assembly of a shipping container and a racking system as in claim 21, in which the side rails comprise an inner rail and an outer rail configured to slide one inside the other, the outer rail formed as an open channel such that when the rails become skewed one to the other to relieve sliding contact each other and when extended telescopically the inner surface of the outer rail be exposed at least partly for servicing.

41. The assembly of a shipping container and a racking system as in claim 38, in which a column of bases stacked one upon another to a height of more than 12 bases can be rolled into a container with a forklift truck.

42. The assembly of a shipping container and a racking system as in claim 21, in which the assembly of the base and posts inside a container is overall wider than the door opening of the container.

43. The assembly of a shipping container and a racking system as in claim 42, in which the assembly of the base and posts inside a container is overall wider than the internal width between the side panels of the container

44. A method for loading one or more vehicles into a container and securing them for shipping comprising the steps of:
a) providing an assembly of a shipping container comprising two longitudinal sidewalls and a floor, and a racking system comprising:
a base comprising a transverse front support connected to a transverse rear support via a pair of longitudinal telescopic side rails enabling adjustment of the a distance between the front and rear supports on which the a vehicle is to be supported, the base having rollers at a front end to enable the base to be rolled along a floor when the a rear end thereof is raised;
four separate removable posts fixed to each of the longitudinal side walls, the posts having arrays of holes formed in them along their lengths; and
connection means connecting the base to the shipping container indirectly via the posts such that the base is located above the floor, creating a space below the base to receive at least part of a further base rolled along the floor into the space, for securing to the container using securing means
b) fitting the four removeable posts into the shipping container;
c) loading a vehicle onto on the base;
d) loading the base onto a handling means;
e) carrying the base into the container;
f) manoeuvring the base within the container by the handling means to connect the front end connectors to the posts;
g) raising the rear end of the base with a or the handling means to enable connection of the rear end connectors to the posts; and
h) withdrawing the handling means from the container.

45. The method as in claim 44, in which the handling means comprises:
a forklift truck linked releasably to the rear end of the base; and
a wheeled jacking trolley able to connect to and support the underside of the base at a position forward of the centre of gravity of the base having adjustable lift arms which can be raised up and down to heights required, the arms having at their tops a hitch engageable with the underside of the base;
the connection of the hitch to the base allowing the base to pivot about the hitch by the raising or lowering of the rear end of the base by the forklift truck; and
allowing the base and the trolley to be moved together along a floor when the base is pushed or pulled by the forklift truck;
the connection being able to be disengaged by either the action of the base being lifted away from the trolley or the arms of the trolley being lowered from a supported base.
